(19) United States
(12) Patent Application Publication
(10) Pub. No.: US 2023/0038431 A1
(43) Pub. Date: Feb. 9, 2023

(54) PLASTICS PARTS FOR ENERGY CHAINS WITH INTEGRATED SENSORS

(71) Applicant: IGUS GMBH, Koeln (DE)

(72) Inventor: Richard HABERING, Koeln (DE)

(21) Appl. No.: 17/758,606

(22) PCT Filed: Jan. 7, 2021
(86) PCT No.: PCT/EP2021/050202

§ 371 Date: Jul. 11, 2022

(30) Foreign Application Priority Data
Jan. 10, 2020 (DE) 20 2020 100 143.4

(51) Int. Cl. F16G 13/16; B22F 10/20; B22F 12/90; B22F 7/08; H02G 11/00; B22F 10/14; B22F 10/18

(52) U.S. Cl. CPC F16G 13/16; B22F 7/08; B22F 10/14; B22F 10/18; B22F 10/20; B22F 12/90; H02G 11/006; B33Y 80/00

(57) ABSTRACT

Energy chains, namely chain parts, in particular chain link plates, therefor and guiding parts of a guide trough for an energy chain. The chain part or guiding part comprises a formed part made from plastic, on which a functional electric circuit with a sensor function is arranged. The functional circuit comprises at least one trace conductor structure, which is formed on the formed part as the carrier of the trace conductor structure, e.g. is applied by an additive manufacturing method.

### FIELD

The invention relates in general to the field of energy chains, for the protected, dynamic guiding of supply lines such as cables, hoses and the like between a first connection point and a second connection point that is movable relative thereto.

The invention relates specifically on the one hand to a part of an energy chain, in particular a part of a chain link such as e.g. a chain link plate, and on the other hand to a guiding part, in particular a glide rail, for a guide trough for energy chains. The invention can be applied in particular but not exclusively in line guiding arrangements that require high travel speeds and/or long travel paths of the energy supply system.

### BACKGROUND

Energy chains typically comprise articulatedly connected chain links and are generally constructed from two strands of chain link plates that are pivotably connected to each other, the link plate strands being spaced apart from each other and connected to each other in a transverse direction by crossbars on each pair of opposite chain link plates.

A line guiding arrangement, in particular in the case of long travel paths, can comprise a guide trough for guiding the energy chain, in which the energy chain is guided. In the guide trough, special guiding parts, such as e.g. glide rails or glide strips, are generally provided in order to reduce friction, i.e. also to reduce the associated forces acting on the energy chain as well as to reduce friction-related wear of the energy chain, in particular in gliding applications.

As the operating life of an energy chain progresses, wear occurs, particularly in the case of high travel speeds and/or long travel paths. Critical wear of a chain link, in particular a chain link plate, that is not detected in a timely manner can lead e.g. to a breakage of the energy chain. In guiding parts of a guide trough too, excessive wear can result in operational disruption or can lead to damage to the energy chain.

To prevent a failure of the energy chain and resulting consequential damage, such as damage to lines being guided and/or production downtime of the machine or equipment being supplied, critical wear should be detected early in order to replace worn parts in good time.

A generic part of an energy chain comprises a formed part made of plastic. The same also applies to guiding parts of the guide troughs. Plastics components of line guiding systems of different constructions have been known for a long time, are well established on the market and are available e.g. from igus GmbH, 51147 Cologne, Germany.

Chain links and glide rails made of plastic offer various advantages over conventional solutions with metal parts, besides weight savings. Wear monitoring is desirable in general and particularly with plastics parts. In addition, it is fundamentally desirable to equip relevant parts with sensor functions that allow improved monitoring, not only but particularly for the purpose of predictive maintenance.

For energy chains, chain link plates are known that are equipped on the plastics formed part with a functional electric circuit having a sensor function for detecting excessive wear.

A chain link plate of this type was already known, e.g. from EP 1 521 015 A2. The functional circuit according to EP 1 521 015 A2 comprises a spring contact element, which is held in a chamber in the chain link plate in a force-fitting manner. The spring contact element is connected to an electric circuit by an electric cable. A wall of the chamber is arranged at a point of the chain link plate that is susceptible to wear, and has an intended breaking point. Deterioration of the wall leads to breakage at the intended breaking point, the opening of the spring contact and the interruption of the electric circuit. This system thus consists of a plurality of mechanical and electrical components and requires complex manufacture.

In WO 2017/129805 A1 (FIGS. 9A and 9B) the applicant describes the attachment of a separate module with an electric circuit for wear detection, namely a radio circuit with a detector element, e.g. in a recess on a chain link plate which is subsequently closed. Here too, production is relatively complex and a suitable receptacle for the module is necessary.

DE 20 2018 100 339 U1 describes a chain link with an integrated wear detector unit that outputs a signal depending on the wear of a wear layer to determine when a wear limit has been reached. DE 20 2019 104 826 U1 relates to a device in which wear of a wear layer between a detection element of a sliding support and a sensor of an energy guiding chain is determined by measuring a distance between the detection element and the sensor.

Further sensors for chain links of energy chains were proposed in WO 2019/201482 A1 and in DE 20 2018 101 842 U1. Here too, simplified, less costly integration into the production process would be desirable. A first object of the present invention therefore consists in proposing parts that are used in or with energy chains, in particular a chain link plate of a chain link or a glide rail of a guide trough, which are equipped with a functional electric circuit for sensing an operating parameter and which can also be produced cost-effectively and reliably in large quantities.

The solution here should be equally suitable for parts of energy chains per se, in particular the chain links thereof, e.g. chain link plates and crossbars, and for guiding parts of guide troughs, in particular glide rails.

### SUMMARY

To achieve this first object it is proposed that, in an energy chain part - in particular a chain link plate, the functional circuit should comprise at least one trace conductor structure which is formed on the plastics formed part of the trace conductor structure, the formed part itself forming the carrier or substrate for the trace conductor structure. The functional circuit can be applied on the preferably pre-manufactured formed part in particular by an additive manufacturing method.

A generic guiding part for a guide trough of a line guiding system, in particular a glide rail or possibly also a glide strip, likewise typically comprises a plastics formed part with a glide surface for an energy chain being guided in the guide trough. To achieve the first object mentioned above, therefore, in a guiding part, it is likewise proposed to arrange on the formed part at least one functional electric circuit with a sensor function for detecting an operating parameter, comprising at least one trace conductor structure, which is formed on the formed part of the trace conductor structure such that the formed part can simultaneously act as the carrier of the trace conductor structure. To this end, the functional circuit can be applied on the preferably pre-manufactured plastics formed part in particular by an additive manufacturing method.

The proposed solution can therefore be used not only for producing structural parts of the chain links, i.e. in particular chain link plates (also called lateral link plates or side parts) and crossbars connecting them (also called cross-members or opening crossbars), but similarly also for those parts of a guide trough, which is in itself optional, that interact with the chain links.

In both cases the proposed construction has, inter alia, the advantage that sensors that have the desired properties and are inexpensive to produce can be directly integrated into the formed parts, i.e. the degree of automation is increased and/or additional manufacturing steps can be omitted.

The term "trace conductor" in the present case is understood to be an individual electrically conductive connecting element of any length with a predefined width and predefined thickness (overall height), wherein the thickness of the trace conductor is significantly smaller relative to its width, in particular by at least a factor of two and generally by about an order of magnitude. They are therefore connecting elements, typically in a flat construction, with geometries similar to trace conductors that are conventional in printed circuit boards.

The formed part can in particular be pre-manufactured, or can already be present in a suitable form before the application of the trace conductor structure or the functional circuit and can thus be utilized as a circuit carrier or substrate. Conventional printed circuit boards or PCBs are therefore unnecessary.

The trace conductor structure according to the invention can be applied by various techniques, e.g. produced by depositing a conductive lacquer on the pre-manufactured formed part and/or printed on the formed part, e.g. by 3D printing. Preferably the entire functional circuit, but at least the trace conductor structure, is applied, and in particular printed, directly on to the pre-manufactured plastics formed part.

The functional circuit can be applied on to the formed part e.g. by an additive metallizing method, by electroplating a metal on to a metallisable plastic, or by thermal deposition, e.g. spraying.

The functional circuit according to the invention can be applied or deposited on the plastics formed part by an additive manufacturing method in general.

This can take place in particular with the aid of suitable MID (molded interconnect devices) technology.

The functional circuit can also be attached by other suitable AM methods that are known per se, and in particular by a method designated as an additive manufacturing method within the meaning of the standard VDI 3405 or DIN EN ISO 17296-2 (Part II).

AM methods allow the inherently automatic, computer-aided manufacture of complex geometries of virtually any kind, typically on the basis of a layer-by-layer construction. Suitable AM methods are in particular direct printing with self-curing of the printing material or 3D printing by polymerization, 3D printing by bonding and 3D printing by sintering/fusing.

The functional circuit here can be completely or integrally produced in a continuous additive manufacturing process, in particular without any other discrete electrical components. In particular, extrusion-based (EB) methods, either with chemical curing or with physical solidification of heated thermoplastic polymers, are suitable for this purpose. For example, the FDM (fused deposition modelling) method appears suitable. MJ (material jetting) methods are also possible, e.g. using photopolymers that solidify by the action of light. So-called BJ (binder jetting) methods, sometimes also known as 3DP methods, are likewise suitable.

In principle, all so-called 3D printing techniques are suitable. EB methods are preferred because of their suitability for relatively viscous, conductive pastes. In particular, an FLM (fused layer modelling) or an FFF (fused filament fabrication) method is preferred for the additive manufacturing.

The formed part can in particular be produced by an injection molding method.

The functional circuit can also be applied by in-mold labelling, or by inserting a printed film into an injection molding tool and back-molding with the plastic. The functional circuit can furthermore be attached by hot stamping (application of an adhesive film under pressure and heat).

A functional circuit is also understood to be a fragment of a circuit. The functional circuit can in particular perform its actual function only by being connected to a further circuit and therefore in particular does not itself have to form an electric circuit. For example, the functional circuit can form an electric two-pole, the electrical properties of which depend on the operating parameter to be detected.

The formed part can have already been pre-manufactured before the functional circuit is applied, and in particular pre-manufactured in one piece, e.g. from a fiber-reinforced polymer.

It is also possible to provide an intermediate layer between the formed part and the additively printed or deposited functional circuit, for instance to promote adhesion or for the purpose of additional electrical insulation.

The trace conductor structure or the functional circuit can be formed on the formed part, and in particular on a surface of the formed part. The trace conductor structure or the functional circuit does not have to be directly accessible from the surface of the finished device - the chain link plate or the guiding part; it can be covered or coated with one or more protective layers in the finished device. The coating can be produced e.g. by overmolding. In the case of a wired signal connection, an access opening to the circuit is preferably left open or cut out for contact purposes, or else a contact device is encapsulated therewith.

An advantage of the solution according to the invention is the relatively cheap manufacture combined with a sturdy construction, which is suitable even for adverse environmental conditions such as e.g. outdoor use.

The formed part can in particular act as a substrate or circuit carrier, preferably as an injection-molded circuit carrier, for the additively applied functional circuit.

The formed part can comprise a thermoplastic or can be produced substantially from a thermoplastic. Thermoplastic materials are particularly suitable, inter alia for recycling. Metal compounds may optionally also be mixed with the plastic, which is advantageous e.g. for the LDS (laser direct structuring) production method for MIDs.

Preferably, the functional circuit is rigidly connected to the formed part by a substance-to-substance bond. The functional circuit is preferably integrated in the formed part or is present as an integral part of the formed part after production.

The functional circuit can comprise a detection region which is sensitive to the operating parameter to be monitored in order to perform a sensor function. In principle, any detection component or detector structure is suitable as the detection region, which is preferably produced integrally during the additive manufacturing of the functional circuit.

The detection region can in particular be a resistive detection region for detecting wear, e.g. by a circuit interruption. Functional circuits with an inductive or capacitive action, e.g. for proximity detection or the like, are also within the scope of the invention. Furthermore, other detection concepts are also possible, for example for temperature measurement or for deformation or force measurement. The term "detection region" refers in particular to a pickup in the metrological sense (see DIN 1319-1), i.e. the part of the apparatus that responds directly to the desired measured variable or the variable to be detected.

In particular to facilitate additive manufacturing, the functional circuit can be applied or provided on a surface of the formed part, and can in particular be integrated into the surface. The finished functional circuit can be at least partially or preferably completely embedded or sunk in a recess structure that has been pre-manufactured on the surface of the formed part. With a recess structure that can be produced with low tolerances by injection molding, it is possible to reduce or compensate for inaccuracies in additive manufacturing that are caused, for example, by flow of the not yet fully cured conductor material.

The preferably complete accommodation of the functional circuit in a top-side recess structure offers inter alia the advantage that a device that has been enhanced with a sensor function remains backward-compatible with the part geometry of an existing device or of one that is already being mass-produced.

The recess structure can remain open on the outside towards the surface after additive manufacturing of the functional circuit, or for better protection, e.g. from environmental influences, can be subsequently encapsulated, optionally using a suitable additive manufacturing technique.

In one embodiment of the chain link plate, the formed part can have a glide surface for gliding interaction with an opposite surface of a component of a line guiding system moving relative to the chain link plate, in particular of a further chain link plate and/or a guiding part of a guide trough.

In a widely used energy chain that is known per se, two consecutive chain link plates of a link plate strand partially overlap with one another in each case at their longitudinal ends and are pivotably connected to one another by an articulated joint. These overlapping regions of the chain link plates can comprise joint pins and/or joint receptacles to form this articulated joint. The joint pin of a chain link plate in this case can be accommodated in a joint receptacle of an overlapping chain link plate. When the chain link plates pivot relative to each other about a pivot axis, these gliding partners glide against each other, which inevitably leads to wear.

Chain link plates can also have other glide surfaces, e.g. if a protrusion of a chain link plate is accommodated in a groove of an overlapping chain link plate for lateral stabilization of the articulated joint.

Furthermore, a chain link plate typically comprises the aforementioned glide surfaces on its narrow sides for gliding against further chain link plates or against a glide rail. Likewise within the scope of the invention is the application on so-called glide shoes for energy chains, which are mounted on the narrow sides as separate formed parts to reduce friction in the case of long travel paths. These glide shoes are also understood as parts in the present sense, which can advantageously be equipped with a functional circuit.

The detection region of the functional circuit can, at least in a new state of the device, be at a predefined distance from the glide surface of the formed part. The detection region can generally be arranged at a predefined position on the formed part.

The detection region can in particular be provided on a surface of the formed part opposite the glide surface.

In one embodiment, the detection region can extend at least partially along a wear limit that is to be detected or can, at least in the new state of the device, be at a distance from the actual glide surface that corresponds to a permissible deterioration of the glide surface such that an exceeding of the wear limit or of the permissible deterioration is detectable by the functional circuit. In this way, the device can be replaced in a timely manner before failure occurs.

The formed part can have a pre-manufactured indentation in which the functional circuit is at least partially or completely embedded.

The functional circuit is preferably deposited directly and/or integrally on the pre-manufactured formed part, in particular by an MID method.

The functional circuit is connected to the formed part preferably by a substance-to-substance bond.

The functional circuit is preferably made from a material having a significantly higher conductivity than the plastic of the formed part, and in particular from a material with a silver, copper and/or carbon content. In this way, the functional circuit can be deposited directly on the formed part, even without additional insulating layers between the body of the formed part and the trace conductor structure of the functional circuit.

Various materials for producing electrically conductive structures by additive manufacturing are already known. For example, printable pastes, liquids or thermoplastics with a silver content, copper content and/or carbon content (for example graphite or carbon black (CB)) can be employed. A silver-based conductive paste is preferably employed, such as for example a liquid resin with silver powder, such as e.g. 5064H from DuPont® (see data sheet MCM5064H/2011). Other mixtures of a polymer matrix with conductive particles, in particular cheaper carbon particles (graphite or CB) are suitable, provided that the finished material of the trace conductors of the functional circuit has significantly higher conductivity than the plastic or tribopolymer of the circuit carrier.

The functional circuit comprises trace conductors, which are preferably applied additively by an AM method and in particular have a layer thickness or thickness of ≤200 µm, preferably of ≤100 µm, e.g. in the range of 5-50 µm, and preferably have a conductor width of 0.5-5 mm. The trace conductors can in particular act as a detection region.

The functional circuit can furthermore have specific contact regions for the releasable contact of the functional circuit, e.g. with a separate evaluation circuit or an energy source, which are applied on the formed part by the same additive manufacturing method as the trace conductor structure of the detection regions. The contact regions preferably have a layer thickness or thickness of ≥200 µm, in particular in the range of 250-500 µm.

The additively manufactured functional circuit is preferably purely passive, i.e. is configured without its own energy source. It can in particular be configured as a two-pole, which is to be connected to a separate evaluation circuit by way of the contact regions. The functional circuit can in particular consist exclusively of trace conductors as a detection region and the contact regions, or can be configured without discrete electrical or electronic components. This particularly simple form also allows e.g. resistive wear detection, in particular by resistive monitoring of an interruption in the trace conductor structure in the detection region of the functional circuit.

However, other types of detection regions or sensors in the sense of measured-variable pick-ups can also be produced by additive manufacturing. Thus, for example, a capacitive or temperature-sensitive sensor structure can also be additively applied. Piezo-resistive structures have already been described in the more recent specialist literature on AM methods. A piezo-resistive detector that can be produced by an AM method was described for example by Leigh SJ, Bradley RJ, et al. ("A Simple, Low-Cost Conductive Composite Material for 3D Printing of Electronic Sensors"; PLoS ONE 7(11); 2012).

A detection region can be used in particular to detect a change of position of the device relative to a further device or component of a line guiding system moving relative to the device. Suitable examples are e.g. the detection of the pivot angle of two chain links that are pivotable relative to each other, or the position detection of the energy chain e.g. by way of the position of an end region relative to the stationary run or relative to the guide trough, etc.

Within the scope of the invention are also in general sensors produced according to the invention for operational monitoring or for the detection of any operating parameters, in particular those representing data that are relevant to service life.

In an embodiment of the device or of the guiding part that is particularly advantageous for guiding parts of guide troughs, the formed part comprises a tribopolymer - a tribologically optimized plastic - and is in particular pre-manufactured from a tribopolymer. Tribopolymers for lubricant-free bearings are known per se and typically comprise a base polymer and microscopic solid lubricants. In addition, the tribopolymer can include reinforcing fibers and/or reinforcing fillers or other fillers. These types of devices and guiding parts are intended to be subject to a certain wear of the base polymer, which will release the solid lubricant particles for solid lubrication with the mating surface. Accordingly, wear detection is particularly advantageous here, and can be achieved inexpensively in an additive manufacturing method. Tribologically optimized polymers (tribopolymers) can be employed in particular for glide rails or glide shoes. A suitable material for this purpose is e.g. a polymer from the iglidur® product range from igus GmbH, D-51147 Cologne.

For chain links or chain link plates, an abrasion-resistant polymer from the igumid® product range from igus GmbH, D-51147 Cologne, is particularly suitable. However, parts of chain links or chain link plates can also comprise regions made from another tribologically optimized polymer or tribopolymer.

A guiding part according to one of the embodiments described can thus be a glide rail with an elongated body in a longitudinal direction and an open cross-section perpendicular to the longitudinal direction. The longitudinal direction of a guiding part corresponds to the longitudinal direction of the guide trough or the direction of travel of the energy chain. The glide rail can in particular be formed as an angled profile. The advantage of these glide rails is that they can be produced inexpensively by injection molding. An open cross-section additionally allows an application of functional circuits on a surface of the formed part opposite or facing away from the glide surface.

The guiding part can have a plurality of functional circuits that are spaced apart from each other in the longitudinal direction of the guiding part. The functional circuits can be used in particular for monitoring the position or the travel of the energy chain along the travel path, in particular if they act as an inductive, capacitive or piezo-resistive switch. The functional circuits can be distributed over an entire length of the guiding part or over a portion of the guiding part.

The guiding part preferably comprises a mounting region for mounting the guiding part on the guide trough. A guide trough for energy chains generally comprises side portions, which are spaced apart from each other in a transverse direction perpendicular to the longitudinal direction of the guide trough, and a channel bottom between the side portions. The side portions in particular here can be made of metal, e.g. of aluminum or steel plate. The side portions and/or the channel bottom can provide contact surfaces for the energy chain, on which the energy chain can travel and in particular glide. These contact surfaces can have glide rails. The side portions can have glide strips, which interact with the broad sides of the chain link plates of an energy chain that travels in the channel.

When the energy chain travels in the guide trough, the broad sides of the chain link plates can come into contact with the glide strip and glide against it. The mounting region can have profile elements for mounting the guiding part, or the glide rail and/or the glide strip, on a side portion of the guide trough, in which case the side portion has a profile that matches the mounting region of the guiding part.

However, the invention relates in particular to plastics formed parts that are parts of an energy chain per se.

A chain link plate according to one of the embodiments described typically comprises e.g. two broad sides and four narrow sides, at least one of the narrow sides being formed for gliding on a glide rail or on narrow sides of further chain link plates. At least one of the broad sides can have a pin and/or a receptacle for forming articulated joints each having a nominal pivot axis between consecutive chain link plates. In one embodiment of the invention, the functional circuit can be directly attached or printed on the one pin and/or in the one receptacle and/or on at least one of the narrow sides. It is optionally also possible for a plurality of coaxial pins/receptacles to be provided.

The invention accordingly also relates to a line guiding system, in particular for long travel paths, for the dynamic guiding of supply lines between two connection points that are movable relative to each other, which comprises an energy chain with at least one chain link plate according to one of the embodiments described above and/or a guide trough for an energy chain with at least one guiding part according to one of the embodiments described above.

The system preferably comprises an evaluation circuit, which has a signaling connection to the functional circuit, in particular a releasable or replaceable connection for signal transmission by way of a line. To this end, for example a special contact interface can be provided between evaluation circuit and functional circuit. Preferably, the system additionally comprises an energy supply, for example a battery for the evaluation circuit.

The line guiding system can have a contact device connected to the evaluation circuit, in particular a contact device with spring contact pins, for a releasable contact of the evaluation circuit with the functional circuit and in particular with the contact regions thereof. This facilitates a replacement of the parts comprising the functional circuit(s), in particular by predictive maintenance. The components that are more complex or expensive to produce can thus be arranged on a part of the system that is not susceptible to wear.

The evaluation circuit can in particular evaluate at least one operating parameter with the aid of the functional circuit(s) and can comprise a communication module, in particular a radio communication module, which is set up to transmit an evaluation result to a higher-level monitoring system. Any known wired or wireless data transfer technologies can be employed for this purpose.

Furthermore, the invention relates to the use of a chain part, in particular a chain link plate, according to one of the embodiments described above, and/or of a guiding part according to one of the embodiments described above in a line guiding system for the dynamic guiding of supply lines between two connection points that are movable relative to each other to allow wear detection, detection of a breakage, detection of a failure and/or detection of deviation from normal travel. A line guiding system that is equipped with a chain part or guiding part according to the invention is advantageous in particular for long travel paths and high travel speeds, where friction and other mechanical stresses occur.

### BRIEF DESCRIPTION OF THE DRAWINGS

Further details, features and advantages of the invention can be taken - without limiting the generality of the above teaching - from the following detailed description of preferred exemplary embodiments with reference to the attached figures, in which:

FIG. 1 is a schematic side view of an exemplary embodiment of a line guiding system;

FIGS. 2A-2D are exemplary embodiments of a chain link plate: perspective (FIG. 2A), in a side view (FIG. 2B), and in sectional views according to FIG. 2B (FIGS. 2C-2D);

FIGS. 3A-3D are further exemplary embodiments of the chain link plate in a perspective view; and

FIG. 4 is a perspective view of an exemplary embodiment of a glide rail for a system as in FIG. 1.

### DETAILED DESCRIPTION

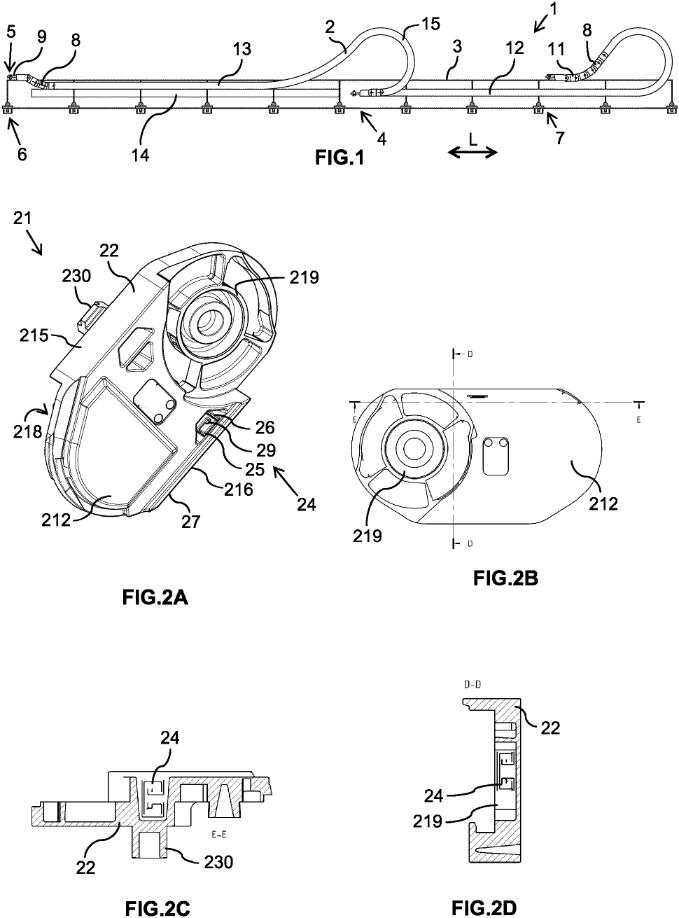

The line guiding system 1 shown purely by way of example in FIG. 1 comprises an energy chain 2 and a guide trough 3 for the energy chain 2. The energy chain 2 guides supply lines 9 from a fixedly positioned connection point 4 to a movable connection point on a moving end 5, e.g. on an equipment part to be supplied. The energy chain 2 here travels as intended along its travel path in a longitudinal direction L between two end positions, indicated here by 6 (left) and 7 (right), the same energy chain 2 being shown in both end positions in FIG. 1 for illustration purposes.

The guide trough 3 extends in the longitudinal direction L at least between the end positions 6 and 7 and is equipped with a number of aligning glide rails 14 over about half its length towards the extended end position 6. The individual glide rail 14 is shown in more detail in FIG. 4. The energy chain 2 forms a lower run 12, an upper run 13 and a deflection curve 15 during travel. In the exemplary embodiment illustrated, the energy chain 2 travels in a gliding manner, i.e. the upper run 13 initially glides on the lower run 12 when the moving end 5 is located between the fixed point 4 and the end position 7, or on the glide rails 14 when the moving end 5 is moving between the fixed point 4 and the extended end position 6.

The energy chain 2 is made up of two link plate strands which are spaced apart from each other in a transverse direction and are connected by suitable crossbars (not shown). The link plate strands and the crossbars form a receptacle space in the energy chain 2, in which the supply lines 9 being guided are accommodated. The link plate strands are made up of chain link plates 11 connected to each other, with two consecutive chain link plates 11 being pivotable relative to each other to a limited degree in each case.

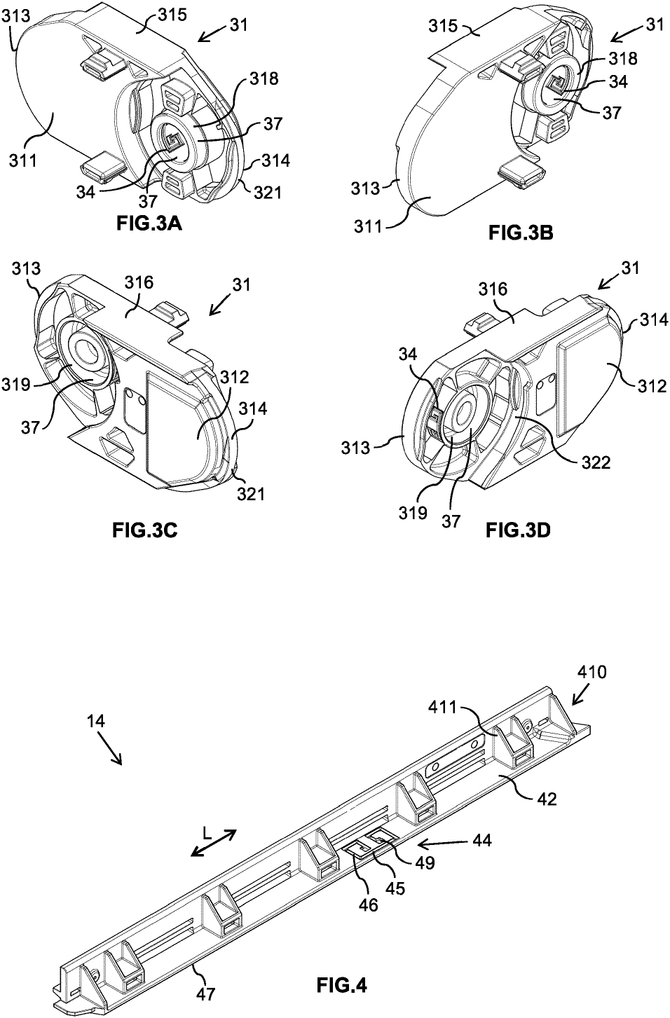

FIGS. 2A-2D show various views of an exemplary embodiment of a chain link plate 21 according to the invention. The body of the chain link plate 21 is configured as a plastics formed part 22, which is produced from a thermoplastic by injection molding. The chain link plate 21 is plate-like and comprises two broad sides 211, 212 and four narrow sides 213, 214, 215 and 216. The broad sides 211, 212 run parallel to the main plane of the chain link plate 21 in which the longitudinal direction and, perpendicular to the longitudinal direction L, the height direction lie. The narrow sides 215, 216 run in the longitudinal direction L, and the narrow sides 212, 213 run in a curved manner substantially in the height direction. The chain link plate 21 furthermore comprises a cylindrical pin 218 (see FIG. 3B) for a receptacle 219 to form an articulated joint with a further chain link plate 21 of the same link plate strand, and a protrusion 230 in the form of a detent lug for connecting to crossbars. FIG. 2C is a section through the protrusion 230. FIG. 2D is a section through the receptacle 219.

The narrow sides 215, 216 of the chain link plate 21 intentionally comprise glide surfaces 27 that are intended for gliding. When the upper run 13 of the energy chain 2 made up of the chain link plates 21 glides on the glide rail 14, 44 or on the lower run 12, the glide surfaces 27 of the narrow sides 216 of the chain link plates 21 glide on the glide surface 47 of the glide rail 14, 44 or on the glide surfaces 27 of the chain link plates 21 of the lower run 12. Particularly in the case of long travel paths or at high speeds, the glide surfaces 27 are subject to unavoidable wear. With an increasing operating life, excessive wear can result in a chain link plate 21 being damaged or even broken, which can lead to the breakage of the energy chain 2 and, in the worst case, to the breakage of supply lines 9 being guided. To prevent this, at least a number of chain link plates 21 of the energy chain 2 are equipped with a special functional circuit 24 for detecting wear.

The functional circuit 24 is applied according to the invention on the body of the chain link plate 21, i.e. on the plastics formed part 22. The formed part 22 here acts as a circuit carrier for the functional circuit 24.

The functional circuit 24 comprises a trace conductor structure 25, with a detection region 26 and two contact regions 29. The functional circuit 24 is passive and is configured as a two-pole and, in this example, it is used for resistive wear detection, namely by a conductor interruption. It consists only of the trace conductors of the detection region 26 and the contact regions 29. The detection region 26 is as a portion of a trace conductor structure, composed e.g. of silver- or copper-containing particles, which were printed on the pre-manufactured formed part 22 by 3D printing. The detection region 26 has a layer thickness of 5-100 µm and a trace conductor width of 0.5-5 mm. The contact regions 29 were likewise printed on the pre-manufactured formed part 22 by 3D printing, preferably in one step with the printing of the detection region 26. However, the contact regions 29 have a greater layer thickness, in particular of 250-500 µm.

The line guiding system 1 furthermore comprises a suitable evaluation circuit (not illustrated), which makes releasable contact with the contact regions 29 of the functional circuit 24 through a contact device with spring contact pins. In this way, the functional circuit 24 becomes part of the evaluation circuit. The wear detection works as follows: friction-related wear causes deterioration or abrasion of the glide surface 27 as far as a wear limit, which is predetermined at the design stage, until the trace conductor is also damaged in the detection region 26, which marks the wear limit or runs along the wear limit, to the extent that a trace conductor interruption occurs. Thus, the electric circuit is interrupted, and critical wear is detectable. Other measuring principles, e.g. inductive or capacitive measuring principles, are also possible.

FIGS. 3A-3D show a further arrangement of the functional circuit 34 on a chain link plate 31. The chain link plate 31 is a so-called cranked chain link plate with a pin 318 on a broad side 311 and a receptacle 320 on the opposite broad side 312, the pin 318 and receptacle 320 of consecutive chain link plates 31 forming the articulated joint thereof. The pin 318 and the receptacle 319 have cylindrical regions with glide surfaces 37. When the two chain link plates 31 pivot relative to each other, the mutually adjacent cylindrical surfaces of the pin 318 and the receptacle 319 glide against each other, i.e. they are susceptible to wear, particularly under high tensile forces, i.e. in comparatively long or rapidly moving energy chains 1. It is also possible to arrange a functional circuit 34 on the glide surfaces 37 of the articulated joint, e.g. in an indentation on the surface of the receptacle 319 or of the pin 318, at a distance from the corresponding glide surface 37. The construction of the functional circuit 34 in this case can correspond to FIG. 2. The deterioration of this glide surface 37 can be detected as a trace conductor interruption in the functional circuit 34.

Further embodiments of functional circuits also lie within the scope of the invention, e.g. with a capacitive, temperature-sensitive or piezo-resistive detection region. They can for example be used for detecting a wear-related change in a distance or in a relative arrangement of two overlapping chain link plates 31. With suitable functional circuits on chain link plates, in particular the occurrence of a clearance in an articulated joint between pin 318 and receptacle 319, or a clearance between the broad sides 311, 312 of the chain link plates 31 in the overlap region, can be detected, e.g. by capacitive or inductive measurement as described e.g. in WO 2019/201482 A1. The corresponding teaching from WO 2019/201482 A1 relating to electrically suitable functional circuits and the arrangement thereof is therefore incorporated herein.

The narrow sides 313, 314 can also have glide surfaces. In chain link plates 31 according to FIGS. 3A-3D, for example, a curved end-face protrusion 321 of a chain link plate 31 is accommodated in a corresponding recess or groove 322 of an overlapping chain link plate 31 for lateral stabilization. A functional circuit 34 can also be provided in this region, e.g. to check that lateral breaking apart does not occur.

FIG. 4 shows a glide rail 14, e.g. for a guide trough 3 according to FIG. 1. The glide rail 14 comprises, as intended, a glide surface 47. In the operating position, the glide rail 14 is arranged in the guide trough 3 such that the glide surface 47 provides a supporting running surface for the energy chain 2. In FIG. 4 the glide rail 14 is shown in a perspective view from the underside, which faces away from the glide surface 47. The glide rail 14 has an elongated body in the longitudinal direction, which is produced as a formed part 42, preferably from a tribopolymer, by injection molding. The body has an open cross-section, which is formed as an angled profile. The body possesses a mounting region 410 for mounting on the side portions of the guide trough 3. The mounting region 410 comprises profile elements 411 for this purpose.

The formed part 42 acts according to the invention as a circuit carrier for the functional circuit 44. In FIG. 4 only one functional circuit 44 is illustrated. The glide rail 14 can also, depending on its overall length, have a plurality of functional circuits 44 spaced apart from each other in the longitudinal direction for detecting wear at various points along the glide rail 14 and/or for plausibility checking. The functional circuits 44 are attached on the surface 48 of the glide rail 14 facing away from the glide surface 47. The functional circuit 44 is substantially made up of trace conductors 45 and contact regions 49, similarly to the functional circuit 24 described above, and operates according to the resistive principle described above. Each functional circuit 44 here can correspond in its construction to the functional circuit 24 from FIG. 2, for example, with a detection region that is sensitive to the operating parameter. It is also possible for a capacitive or inductive principle to be utilized in the functional circuit 44 as an alternative or in addition.

The functional circuits 24, 34, 44 from FIGS. 2-4 here comprise at least one trace conductor structure 25, 35, which is applied by a suitable additive manufacturing method directly on the formed part 22, 32 or 42 that acts as a carrier or substrate for the trace conductor structure 25, 35 and has by comparison considerably lower conductivity.

### REFERENCE SIGNS LIST

FIG. 1
1 Line guiding system
2 Energy chain
3 Guide trough
4 Fixed point
5 Moving end
6, 7 End positions
9 Supply lines
11 Chain link plate
12 Lower run
13 Upper run
15 Deflection curve
14 Glide rail
L Longitudinal direction

FIGS. 2A-2D
21 Chain link plate
22 Formed part
24 Functional circuit
25 Trace conductor structure
26 Detection region
29 Contact region
27 Glide surfaces
28 Indentation
211, 212 Broad sides
213, 214, 215, 216 Narrow sides
218 (Joint) pin
219 (Joint) receptacle
L Longitudinal direction

FIGS. 3A-3D
31 Chain link plate
34 Functional circuit
35 Trace conductor structure
37 Glide surfaces
311, 312 Broad side
313, 314, 315, 316 Narrow sides
318 Pin
319, 320 Receptacle
321 Protrusion
322 Groove

FIG. 4
14 Glide rail
42 Formed part
44 Functional circuit
47 Glide surface
48 Surface
410 Mounting region
411 Profile elements

What is claimed is:

1-23. (canceled)

24. A chain link part, for an energy chain, comprising:
a plastic formed part, on which at least one functional electric circuit with a sensor function for acquisition of an operating parameter is arranged,
wherein the functional circuit comprises at least one trace conductor structure, which is formed directly on the formed part,
wherein the formed part itself forms a carrier of the trace conductor structure,
wherein the functional circuit is applied by an additive manufacturing method on the formed part made of plastic.

25. The chain link part according to claim 24, wherein the plastic formed part is a premanufactured plastic formed part which operates as a circuit carrier for the functional circuit.

26. The chain link part according to claim 25, wherein the premanufactured plastic formed part comprises an injection-molded plastic circuit carrier for the functional circuit.

27. The chain link part according to claim 24, wherein the functional circuit comprises a detection region that is sensitive to the operating parameter.

28. The chain link part according to claim 27, wherein the formed part comprises a glide surface on a narrow side of the chain link part to glide on a further chain link part and/or on a glide rail of a guide trough.

29. The chain link part according to claim 28, wherein the detection region is at a predefined distance from the glide surface, on a surface opposite the glide surface.

30. The chain link part according to claim 29, wherein the functional circuit is applied on a surface of the formed part, and is integrated into the surface.

31. The chain link part according to claim 27, wherein the detection region extends at least partially along a wear limit to be detected such that an exceeding of the wear limit is detectable by the functional circuit.

32. The chain link part according to claim 24, wherein the formed part comprises an indentation in which the functional circuit lies at least partially.

33. The chain link part according to claim 24, wherein the trace conductor structure is integrally deposited on the formed part, and is connected to the formed part by a substance-to-substance bond.

34. The chain link part according to claim 24, wherein the trace conductor structure is made of a material having significantly higher conductivity than the plastic of the formed part.

35. The chain link part according to claim 34, wherein the trace conductor structure is made of a material with a silver, copper and/or carbon content.

36. The chain link part according to claim 24, wherein the trace conductor structure comprises trace conductors that are applied additively by an additive manufacturing method and have a first layer thickness, with a conductor width of 0.5-5 mm; as well as contact regions for a releasable contact, which are applied additively by the additive manufacturing method and which have a second layer thickness, which is greater than the first layer thickness.

37. The chain link part according to claim 36, wherein the functional circuit is of passive configuration and consists of the trace conductors and contact regions, and is used for resistive wear detection by a conductor interruption.

38. The chain link part according to claim 24, wherein the functional circuit comprises an inductive, a capacitive, a temperature-sensitive or a piezo-resistive detection region, wherein the detection region detects a change of position of the chain link part relative to a further chain link part that is moving relative to the chain link part.

39. The chain link part according to claim 24, wherein the formed part comprises a tribopolymer, which comprises a base polymer and solid lubricants.

40. The chain link part according to claim 24, having two broad sides and four narrow sides,
wherein at least one of the narrow sides is formed for gliding on a glide rail or narrow sides of further chain link parts, and/or
wherein at least one of the broad sides comprises at least one pin and/or at least one corresponding receptacle to form articulated joints each having a nominal pivot axis between consecutive chain link parts, wherein the functional circuit is attached or printed on the at least one pin and/or on the at least one receptacle and/or on at least one of the narrow sides.

41. The chain link part according to claim 24, wherein the chain link part is a chain link plate.

42. The chain link part according to claim 24, wherein the chain link part is disposed in a line guiding system having the energy chain, for dynamic guiding of supply lines between two connection points that are movable relative to each other.

43. A guiding part of a guide trough of a line guiding system with an energy chain, comprising:
a plastic formed part, which comprises a glide surface for the energy chain guided in the guide trough,
wherein on the formed part at least one functional electric circuit with a sensor function for acquisition of an operating parameter is arranged,
wherein the functional circuit comprises at least one trace conductor structure, which is formed directly on the formed part,
wherein the formed part itself forms a carrier of the trace conductor structure,
wherein the functional circuit is applied by an additive manufacturing method on the formed part made of plastic.

44. A line guiding system having an energy chain, for dynamic guiding of supply lines between two connection points that are movable relative to each other, comprising:
a chain link part of the energy chain and/or a guiding part of a guide trough for the energy chain
wherein the chain link part of the energy chain comprises
a plastic formed part, on which at least one functional electric circuit with a sensor function for acquisition of an operating parameter is arranged,
wherein the functional circuit comprises at least one trace conductor structure, which is formed directly on the formed chain link part,
wherein the formed chain link part itself forms a carrier of the trace conductor structure,
wherein the functional circuit is applied by an additive manufacturing method on the formed chain link part made of plastic,
wherein the guiding part of the guide trough for the energy chain comprises
a plastic formed part, which comprises a glide surface for the energy chain guided in the guide trough,
wherein on the formed guiding part at least one functional electric circuit with a sensor function for acquisition of an operating parameter is arranged,
wherein the functional circuit comprises at least one trace conductor structure, which is formed directly on the formed guiding part,
wherein the formed guiding part itself forms a carrier of the trace conductor structure,
wherein the functional circuit is applied by an additive manufacturing method on the formed guiding part made of plastic, and
wherein the system further comprises an evaluation circuit, which has a releasable signaling connection, to the functional circuit.

45. The system according to claim 44, wherein the system comprises a contact device connected to the evaluation circuit for a releasable contact of the evaluation circuit with the functional circuit.

46. The system according to claim 44, wherein the evaluation circuit evaluates at least one operating parameter with aid of the functional circuit(s) and includes a communication module, which is set up to transmit an evaluation result to a higher-level monitoring system.
